(19) United States
(12) Patent Application Publication
(10) Pub. No.: US 2011/0180981 A1
(43) Pub. Date: Jul. 28, 2011

(54) INTERCHANGEABLE CUTTING BOARD DEVICE WITH DETACHABLE CUTTING ASSEMBLY

(76) Inventors: Robert Radi, La Quinta, CA (US); Qimim Wang, La Quinta (CA)

(21) Appl. No.: 13/014,648

(22) Filed: Jan. 26, 2011

Related U.S. Application Data
(60) Provisional application No. 61/298,858, filed on Jan. 27, 2010.

(51) Int. Cl. A47J 47/00

(52) U.S. Cl. 269/16; 269/293

(57) ABSTRACT

The present invention provides, in at least one embodiment, a multipurpose cutting board and food preparation device. The device comprises a housing structure, a rail disposed on one edge of the housing structure, interchangeable color coded cutting boards, and a detachable cutting assembly. The cutting assembly may include interchangeable blades tailored for specific types of food cuts, e.g., julienne and chopping, slicing, and dicing. The cutting assembly provides an additional cutting option and flexibility with the interchangeable blades. The housing structure includes a storage area for storing the interchangeable color coded cutting boards not in use. The storage area promotes better organization of the cutting boards and the color coding helps identify the appropriate cutting board for the task.

### CROSS REFERENCE TO RELATED APPLICATIONS

This application claims priority under 35 U.S.C. §119(e) to U.S. Provisional Application No. 61/298,858, filed Jan. 27, 2010, and entitled “FOOD CUTTING AND PREPARATION DEVICE WITH DETACHABLE CUTTING ASSEMBLY AND INTERCHANGEABLE BLADES,” the disclosure of which is hereby incorporated by reference in its entirety.

### BACKGROUND OF THE INVENTION

1. Field of Invention

The present invention relates generally to food cutting devices and more particularly to a food cutting and preparation device with interchangeable cutting boards and a detachable cutting assembly with interchangeable blades.

2. Description of Related Art

A cutting board is a durable board used to place material that will be cut. The most common cutting board is the kitchen cutting board for use preparing food, but other types exist for cutting raw materials such as leather or plastic. Kitchen cutting boards are often made of wood or plastic, but there are also cutting boards made of glass, steel, marble or corian, which are easier to clean than wooden or plastic cutting boards, but tend to damage a knife's edge, since knife edges are delicate and can easily be blunted or chipped by a surface that is too abrasive or hard.

A good cutting board material must be soft, easy to clean, and non-abrasive, but not fragile to the point of being destroyed. Hard cutting boards can, however, be used for food preparation tasks that do not require a sharp knife, like cutting cheese or making sandwiches.

In choosing a cutting surface, there are pros and cons to each depending on application. Wood has some advantages over plastic in that it is somewhat self-healing; shallow cuts in the wood will close up on their own. Wood also has natural anti-septic properties. Hardwoods with tightly grained wood and small pores are best for wooden cutting boards. Good hardness and tight grain helps reduce scoring of the cutting surface and absorption of liquid and dirt into the surface. Wood cutting boards should never be placed in the dishwasher, or left immersed for long periods, as the wood or glue may be affected. Plastics are a more sanitary material than wood for cutting boards because they allow rinsing with harsher cleaning chemicals such as bleach and other disinfectants without damage to the board or retention of the chemicals to later contaminate food.

Glass, steel, and marble are easy to keep clean, but should not be used as cutting boards because they can damage the knives because of the hardness of the material. Additionally, if used for chopping instead of slicing, glass can shatter or chip itself, contaminating the food. The tops of glass cutting boards are slippery, meaning the cutting board can slip and break while cutting, handling, or washing, leading to hand injuries.

Regardless of the material, regular maintenance of a cutting board is important. Sanitation with cutting boards is a delicate process, because bacteria can reside in grooves produced by cutting, or in liquids left on the board. For this reason, raw meat should be cut on separate cutting boards from cooked meat, vegetables or other foods. For this sanitation purpose, multiple cutting boards are needed for many households. Though, many other reasons exist to have multiple cutting boards. Some cutting boards work better with certain sharper knives. Some cutting boards work better when hammering or tenderizing meat. Some cutting boards are easier to wash. Some cutting boards are needed while the raw meat cutting board is in the dishwasher or waiting to be hand washed.

U.S. Pat. No. 7,758,029 describes a cutting board assembly that has a housing that has a plurality of side walls, a top wall and bottom wall that together define an internal storage space that can store replaceable cutting sheets inside.

U.S. Pat. No. 7,614,618 describes a cutting board system with a main chopping board and several additional chopping boards connected by means of a movable connection structure, and storage room can be saved because many chopping boards can fold into an integral board system.

U.S. Pat. No. 7,530,558 describes a cutting board assembly having drawer with variable volume containment space. A volume of food retained within the containment space may be measured using the increments marked along the length or the width of the drawer.

Conventional cutting board devices lack many useful features that improve the cutting experience, such adequate organization for multiple cutting boards, more options by having a cutting attachment, and saving space when the cutting attachment is not needed.

### SUMMARY OF THE INVENTION

The present invention overcomes these and other disadvantages of the prior art by providing, in at least one embodiment, a multipurpose cutting board and food preparation device. The device comprises a housing structure, a rail disposed on one edge of the housing structure, interchangeable color coded cutting boards, and a detachable cutting assembly.

In an embodiment of the invention, a device comprises: a housing structure having a top and a bottom; a recessed area on the top of the housing structure; a top cutting board on the top of the housing structure and coupled to the recessed area; a storage area in the housing structure, the storage area configured to store one or more stored cutting boards, wherein the top cutting board is a different color than the stored cutting boards; a hinged rail on the top of the housing structure; and a detachable cutting attachment assembly coupled the hinged rail. The detachable cutting attachment assembly may comprise a container configured to receive the cut food and slide along the hinged rail. The device may further comprise interchangeable blades that fit into the cutting attachment assembly or the top cutting board. The interchangeable blades may comprise julienne and chopping, slicing, or dicing. The recessed area and the top cutting board may be curved.

In another embodiment, a device comprises: a housing structure; a cutting board on the top of the housing structure; a storage area in the housing structure, the storage area configured to store one or more stored cutting boards; and a hinged rail, the hinged railed configured to receive a detachable cutting attachment assembly. The device may further comprise a recessed area in the housing structure. The cutting board may be a different color than the stored cutting boards. The detachable cutting attachment assembly may be coupled the hinged rail. The detachable cutting attachment assembly may comprise a container configured to receive the cut food and slide along the hinged rail. The device may further comprise interchangeable blades that fit into the cutting board. The interchangeable blades may comprise julienne and chopping, slicing, or dicing. The recessed area and the top cutting board may be curved.

In another embodiment, a device comprises: a housing structure; a cutting board on the top of the housing structure; a storage area in the housing structure; and a detachable cutting attachment assembly coupled the housing structure, wherein the detachable cutting attachment can be both attached and detached from the housing structure. The cutting board may be a different color than the stored cutting boards. The device may further comprise a hinged rail, the hinged railed configured to receive the detachable cutting attachment assembly.

Embodiments of the present invention have several advantages over existing technology. For example, the cutting boards and blades can be interchanged with other cutting boards and blades. The curved edge provides a better grip and as such the cutting board is easier to wash and handle. A food preparer has more flexibility to select different cutting styles, e.g., julienne and chopping, slicing, and dicing, by simply switching to the appropriate blade, increasing efficiency and lessening the burden to the food preparer. Another advantage is the cutting assembly is detachable, which makes it easier to store the device in the kitchen and provide more space to cut on the board using knives and utensils. Additionally, storage of the cutting boards within the storage area helps the food preparer stay organized. Further, the color coded cutting boards help the food preparer identify the appropriate cutting board for the task.

The foregoing, and other features and advantages of the invention will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a multipurpose cutting board and food preparation device according to an embodiment of the invention;

FIG. 2 illustrates an opposite view of the cutting board and food preparation device of FIG. 1 to highlight the hinged rail portion;

FIG. 3 illustrates the cutting board and food preparation device of FIG. 1 with a cutting attachment assembly detached;

FIG. 4 illustrates the cutting board and food preparation device of FIG. 1 with the cutting attachment assembly attached; and

FIG. 5 illustrates several exemplary interchangeable blades for the cutting attachment assembly according to an embodiment of the invention.

### DETAILED DESCRIPTION OF EMBODIMENTS

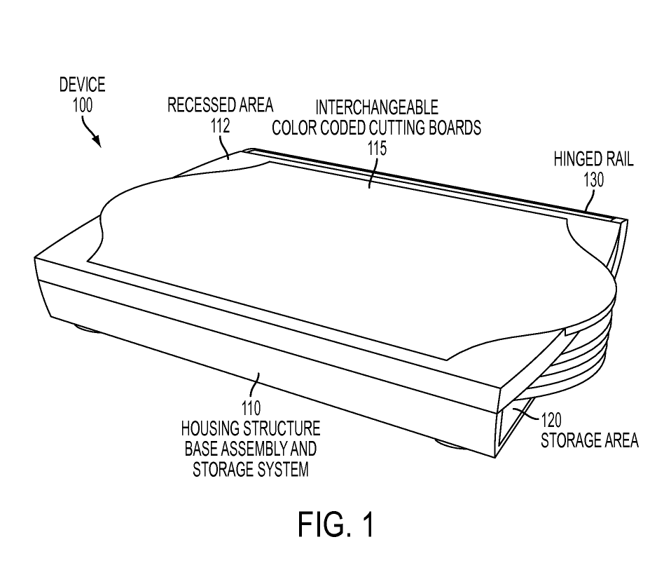

Further features and advantages of the invention, as well as the structure and operation of various embodiments of the invention, are described in detail below with reference to the accompanying FIGS. 1-5, wherein like reference numerals refer to like elements. Although embodiments of the invention are described in the context of particular types of foods and particular types of the cutting board materials, one of ordinary skill in the art readily appreciates that the present invention is applicable to other foods and materials.

In an embodiment, the present invention provides a multipurpose cutting board and food preparation device. The device comprises a housing structure, a rail disposed on one edge of the housing structure, interchangeable color coded cutting boards, and a detachable cutting assembly. The cutting assembly may include interchangeable blades tailored for specific types of food cuts, e.g., julienne and chopping, slicing, and dicing. The cutting assembly provides an additional cutting option and flexibility with the interchangeable blades. The housing structure includes a storage area for storing the interchangeable color coded cutting boards not in use. The storage area promotes better organization of the cutting boards and the color coding helps identify the appropriate cutting board for the task.

FIG. 1 illustrates a multipurpose cutting board and food preparation device 100 according to an embodiment of the invention. The multipurpose cutting board and food preparation device 100 comprises a housing structure 110, a storage area 120 within the housing structure 110, and a hinged rail 130. The housing structure 110 comprises a top surface featuring a recessed area 112 for receiving an interchangeable color coded cutting board 115. Multiple color coded cutting boards 115 are included with the device 100. One cutting board 115 is placed within the recessed area 112 for usage. The remaining cutting boards 115 can be stored within the storage area 120. In an embodiment of the invention, the cutting boards 115 are color coded as follows: green for vegetable foods, yellow for poultry, red for beef, blue for fish, and purple for dairy products. The cutting boards 115 can be made of any suitable material, such as wood, plastic, rubber, glass, steel, marble. All the cutting boards 115 may be made from the same material, each from different materials, or a mixture thereof. The cutting boards 115 can have curve shaped ends which make them easier to grip for removal and handling during cutting and washing.

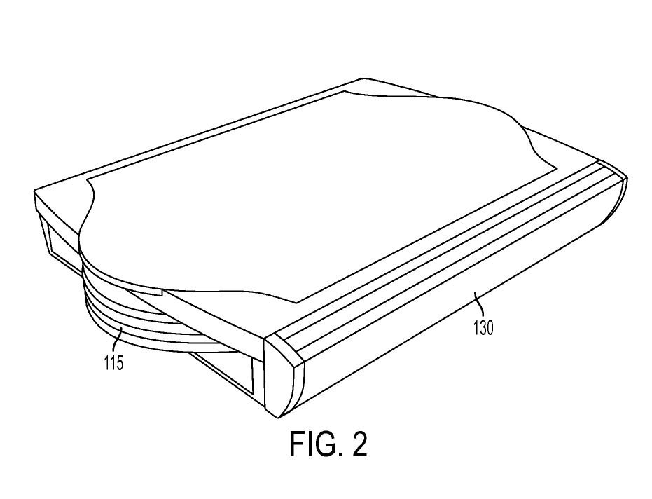

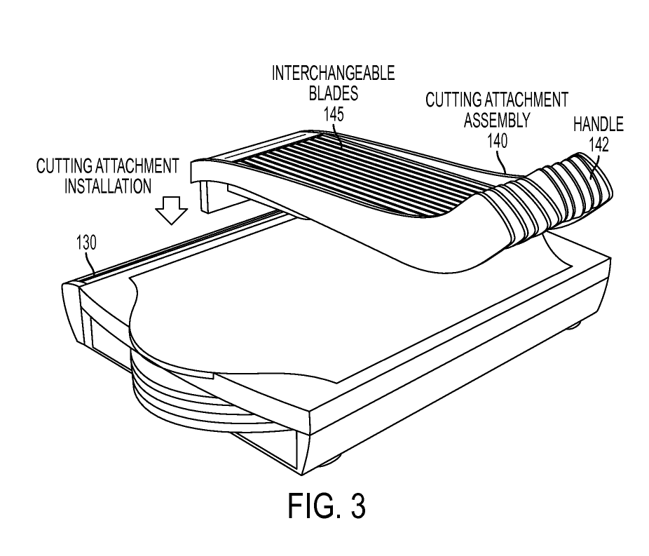

FIG. 2 illustrates an opposite view of the cutting board and food preparation device 100 to highlight the hinged rail 130. The hinged rail 130 comprises a groove for receiving a cutting attachment assembly (the cutting attachment assembly 140 is shown in FIG. 3). Without the cutting attachment assembly 140 present, the cutting boards 115 have more open space and can be used with standard knives and cutting utensils.

FIG. 3 illustrates the cutting board and food preparation device 100 with an undetached cutting attachment assembly 140. The cutting attachment assembly 140 is installed in the device 100 by inserting a specially configured edge of the assembly 140 into the groove of the hinged rail 130. The hinged rail 130 is able to pivot about an axis in order to raise and lower the cutting attachment assembly 140 above the cutting board 115. The cutting attachment assembly 140 comprises a handle 142 and several interchangeable blades 145.

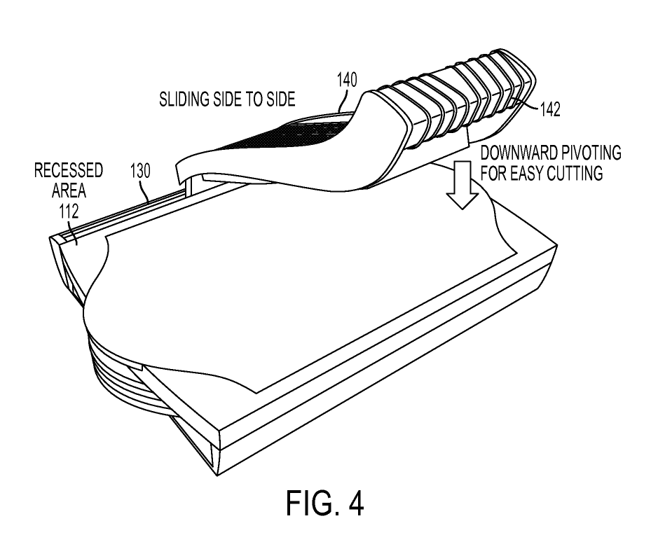

FIG. 4 illustrates the cutting board and food preparation device 100 with the cutting attachment assembly 140 attached. The cutting attachment assembly 140 is able to pivot about the hinged rail 130 in order to raise and lower it. The cutting attachment assembly 140 is also able to slide laterally from one side of the device 100 to another side. A food substance is placed between the cutting attachment assembly 140 and the cutting board 115 attached to the recessed area 112. Downward force on the handle 142 of the cutting attachment assembly 140 drives the blade 145 through the food substance.

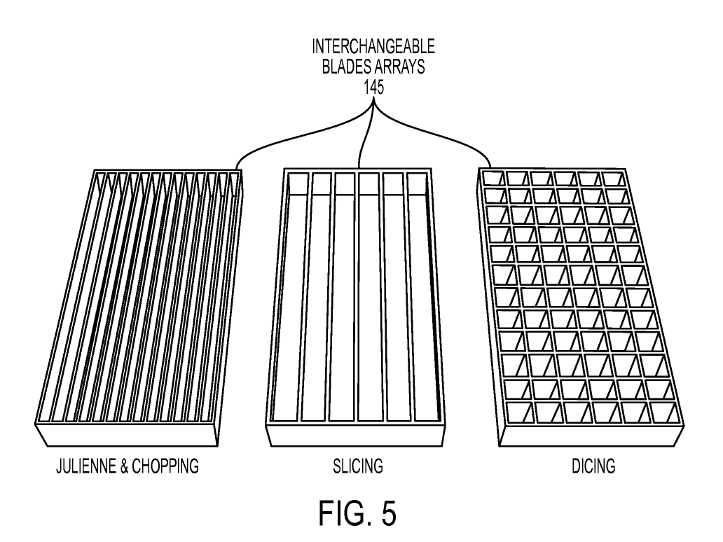

FIG. 5 illustrates several exemplary interchangeable blades 145 for the cutting attachment assembly 140 according to an embodiment of the invention. The exemplary interchangeable blades 145 are configured to produce certain cuts such as, but not limited to julienne and chopping, slicing, and dicing. The interchangeable blades 145 each fit into the cutting attachment assembly 140, where one cutting attachment assembly is configured to receive multiple types of interchanges blades 145. In order to switch out the interchangeable blades 145 safely, the cutting attachment assembly can include a switch or fastener.

In another embodiment of the invention, the assembly 140 includes a receptacle container (not shown) attached to the top side of the assembly 140 in order to collect food that may go through the blades 145, hence providing housing for such foods, and also functioning as a shield/guard to prevent foods from becoming airborne if too much pressure is applied on the handle 142.

In an alternative embodiment of the invention, the blades 145 are installed in the cutting boards through an opening (not shown) in the boards themselves. A closed shape (as a board like configuration) is installed in the assembly 140 in place of the blades, so that the food is pushed through the blades (installed in the cutting board), and ends up in the storage area 120 below where there is a receptacle container (not shown). Therefore, each cutting board would have an opening where the blades (in any of the configurations shown in FIG. 5) can be installed.

The process includes lifting off the cutting board 115 that was previously in use, removing the cutting board 115 out of the storage area and selecting the desired cutting board 115 to insert in the opening formed by the recessed area 112. If the cutting attachment 140 assembly is desired, picking the desired blade 145 and attaching them to the hinged rail 130. Then, sliding the cutting attachment 140 to the place where the food is at, and using the handle 142 to press down and cut the food. The cut food is stored in a container attached to the cutting assembly. The cutting board can be removed and washed.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A device comprising:
a housing structure having a top and a bottom;
a recessed area on the top of the housing structure;
a top cutting board on the top of the housing structure and coupled to the recessed area;
a storage area in the housing structure, the storage area configured to store one or more stored cutting boards, wherein the top cutting board is a different color than the stored cutting boards;
a hinged rail on the top of the housing structure; and
a detachable cutting attachment assembly coupled the hinged rail.

2. The device of claim 1, wherein the detachable cutting attachment assembly comprises a container configured to receive the cut food.

3. The device of claim 1, wherein the detachable cutting attachment assembly slides along the hinged rail.

4. The device of claim 1, further comprising interchangeable blades that fit into the cutting attachment assembly or the top cutting board.

5. The device of claim 4, wherein the interchangeable blades comprise julienne and chopping, slicing, or dicing.

6. The device of claim 1, wherein the recessed area and the top cutting board are curved.

7. A device comprising:
a housing structure;
a cutting board on the top of the housing structure;
a storage area in the housing structure, the storage area configured to store one or more stored cutting boards; and
a hinged rail, the hinged railed configured to receive a detachable cutting attachment assembly.

8. The device of claim 7, further comprising a recessed area in the housing structure.

9. The device of claim 7, wherein the cutting board is a different color than the stored cutting boards.

10. The device of claim 7, further comprising a detachable cutting attachment assembly coupled the hinged rail.

11. The device of claim 10, wherein the detachable cutting attachment assembly comprises a container configured to receive the cut food.

12. The device of claim 10, wherein the detachable cutting attachment assembly slides along the hinged rail.

13. The device of claim 10, further comprising interchangeable blades that fit into the cutting attachment assembly or the cutting board.

14. The device of claim 13, wherein the interchangeable blades comprise julienne and chopping, slicing, or dicing.

15. The device of claim 7, wherein the recessed area and the top cutting board are curved.

16. A device comprising:
a housing structure;
a cutting board on the top of the housing structure;
a storage area in the housing structure; and
a detachable cutting attachment assembly coupled the housing structure, wherein the detachable cutting attachment can be both attached and detached from the housing structure.

17. The device of claim 16, wherein the cutting board is a different color than the stored cutting boards.

18. The device of claim 16, further comprising a hinged rail, the hinged railed configured to receive the detachable cutting attachment assembly.
